(19) United States
(12) Patent Application Publication
(10) Pub. No.: US 2023/0304747 A1
(43) Pub. Date: Sep. 28, 2023

(54) ERG COOLER FOR BRAZING JOINT AND METHOD OF MANUFACTURING THE SAME

(71) Applicants: HYUNDAI MOTOR COMPANY, Seoul (KR); KIA CORPORATION, Seoul (KR); HYUNDAI BNGSTEEL CO., LTD., Changwon-si (KR)

(72) Inventors: Jong Cheon Kim, Bucheon-si (KR); Sang Heon Cho, Changwon-si (KR); Dong Eun Kim, Gimhae-si (KR); Sang Hun Lee, Changwon-si (KR)

(21) Appl. No.: 18/070,464

(22) Filed: Nov. 28, 2022

(30) Foreign Application Priority Data
Mar. 28, 2022 (KR) 10-2022-0037848

(51) Int. Cl. F28F 3/00

(52) U.S. Cl. CPC F28F 3/00; F28F 2275/04; F28F 21/083

(57) ABSTRACT

The present disclosure provides an EGR cooler for brazing joint including an inlet configured to form an inlet area through which intake air and recirculation exhaust gas are supplied, a heat exchange unit formed with a gas tube connected to the inlet and through which the supplied intake air and the recirculation exhaust gas pass, and an outlet configured to form an outlet area through which the intake air and the recirculation exhaust gas mixed by passing through the heat exchange unit are discharged, in which the inlet, the heat exchange, and the outlet are brazing-joined, and a guide pattern configured to guide the flow of a filler metal so that surface energy of the filler metal applied for brazing joint is increased is transferred to each joined area.

### CROSS-REFERENCE TO RELATED APPLICATION

This application claims under 35 U.S.C. § 119(a) the benefit of priority to Korean Patent Application No. 10-2022-0037848 filed on Mar. 28, 2022, the entire contents of which are incorporated herein by reference.

### BACKGROUND

### (a) Technical Field

The present disclosure relates to an ERG cooler for brazing joint and a method of manufacturing the same, and more specifically, to an ERG cooler for brazing joint capable of improving spreading performance of a filler metal by maximizing the surface energy of a base material and a method of manufacturing the same.

### (b) Background Art

Recently, environmental problems such as global warming have been discussed, and regulations on exhaust gases are being strengthened, and in particular, standards for the exhaust gases from automobiles are being gradually strengthened and applied.

Specifically, diesel engines for passenger vehicles are required to reduce the amount of NOx to 80 mg/km based on the EURO-6 standard, and the automobiles' related companies employ new technologies such as an exhaust gas circulation (EGR) device, a lean NOx trap (LNT), and a selective catalytic reduction (SCR) device in response thereto.

The EGR device may include a high pressure exhaust gas recirculation (HP-EGR) device for recirculating exhaust gases at a front end of a catalyst and a low pressure exhaust gas recirculation (LP-EGR) device for recirculating exhaust gases at a rear end of the catalyst.

At this time, in order to cool the recirculation exhaust gas, an EGR cooler is disposed in an exhaust gas recirculation line, and the EGR cooler may be made of a stainless material having high corrosion resistance against a high temperature state and condensed water.

However, since the EGR cooler made of a stainless steel is heavy, has low heat transfer efficiency, has poor moldability, and has high overall parts price, research on an EGR cooler made of aluminum with high heat transfer efficiency, good moldability, and relatively inexpensive parts is being conducted.

As described above, the matters described in the background technique section are prepared for better understanding of the background of the disclosure, and may include matters that are not the related art already known to those skilled in the art to which this technology pertains.

### SUMMARY

An object of the present disclosure is to provide an EGR cooler for brazing joint, which may increase surface energy (area) of a filler metal contact surface and maximize interaction energy between a base material and a filler metal upon brazing joint by applying a plurality of protrusions on an outer circumferential surface of a joint pipe body in order to improve brazing joint performance for expanding the use of low-alloy ferritic stainless steel in an EGR cooler system, thereby improving brazing joint quality through the improvement in spreadability of the filler metal, and accordingly, may improve the quality and save costs by minimizing the use of expensive nickel-based filler metal containing a nickel component, and a method of manufacturing the same.

According to the present disclosure, there is provided an EGR cooler for brazing joint including: an inlet configured to form an inlet area through which intake air and recirculation exhaust gas are supplied, a heat exchange unit formed with a gas tube connected to the inlet and through which the supplied intake air and the recirculation exhaust gas pass, and an outlet configured to form an outlet area through which the intake air and the recirculation exhaust gas mixed by passing through the heat exchange unit are discharged, in which the inlet, the heat exchange, and the outlet are brazing-joined, and a guide pattern configured to guide the flow of a filler metal so that surface energy of the filler metal applied for brazing joint is increased is transferred to each joined area.

Here, the guide pattern is formed with a pattern in which a plurality of protrusions protrude.

In addition, the guide pattern has an outer circumferential surface of the protrusion formed to be rounded.

In addition, the guide pattern has the protrusion formed to protrude at a maximum height of less than 60 μm.

In addition, the guide pattern is formed by the protrusions spaced apart from each other by the same gap

Meanwhile, the heat exchange unit is provided with a housing, the gas tube disposed inside the housing, and end plates disposed to face the inlet and the outlet, respectively.

In addition, the heat exchange unit has the protrusions formed at both ends with respect to a surface of the gas tube.

In addition, the heat exchange unit is made of ferrite stainless steel.

Meanwhile, according to the present disclosure, there is provided a method of manufacturing an EGR cooler for brazing joint, the method including a rolling operation of rolling a base material applied to each joined area of an inlet, a heat exchange unit, and an outlet of an EGR cooler for brazing joint, a heat-treating operation of heat-treating the base material passing through the rolling operation, and a guide pattern forming operation of forming a guide pattern by allowing the heat-treated base material to pass through a rolling roller on which a pattern is transferred and composed of a plurality of protruding protrusions, in which the guide pattern has an outer circumferential surface of the protrusion formed to be rounded and protrudes at a maximum height of less than 60 μm, and a plurality of protrusions are formed to have the same gaps.

According to the present disclosure, it is possible to increase surface energy (area) of the filler metal contact surface and maximize interaction energy between the base material and the filler metal upon brazing joint by applying the plurality of protrusions on the outer circumferential surface of the joint pipe body in order to improve brazing joint performance for expanding the use of low-alloy ferritic stainless steel in the EGR cooler system, thereby improving the brazing joint quality through the improvement in the spreadability of the filler metal.

Accordingly, according to the present disclosure, it is possible to improve the quality and save costs by expanding the use of the low alloy ferrite stainless steel and minimizing the use of expensive nickel-based filler metal containing the nickel component.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

The above and other features of the disclosure are discussed infra.

### BRIEF DESCRIPTION OF THE DRAWINGS

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 is a view showing an EGR cooler for brazing joint according to an embodiment of the present disclosure;

FIG. 2 is a view showing a heat exchange unit for the EGR cooler for brazing joint according to an embodiment of the present disclosure;

FIG. 3 is a view showing a conventional heat exchange unit for an EGR cooler for brazing joint;

FIG. 4A is a view showing spreadability of a filler metal for the EGR cooler for brazing joint according to an embodiment of the present disclosure;

FIG. 4B is a view showing spreadability of a filler metal for the EGR cooler for brazing joint according to an embodiment of the present disclosure;

FIG. 5 is a view showing a brazing joint area of the EGR cooler for brazing joint according to an embodiment of the present disclosure; and

FIG. 6A is a view showing a shape of a protrusion for the EGR cooler for brazing joint according to an embodiment of the present disclosure; and

FIG. 6B is a view showing a shape of a protrusion for the EGR cooler for brazing joint according to an embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION

Hereinafter, preferred embodiments according to the present disclosure will be described in detail with reference to the accompanying drawings.

Advantages and features of the present disclosure and a method for achieving the same will become apparent with reference to the embodiments described below in detail in conjunction with the accompanying drawings.

However, the present disclosure is not limited to embodiments disclosed below but will be implemented in various different forms, and only these embodiments are provided so that the disclosure of the present disclosure will be thorough and complete and will fully convey the scope of the present disclosure to those skilled in the art to which the present disclosure pertains, and the present disclosure is defined by the description of the claims.

In addition, in the description of the present disclosure, when it is determined that related known techniques may obscure the gist of the present disclosure, a detailed description thereof will be omitted.

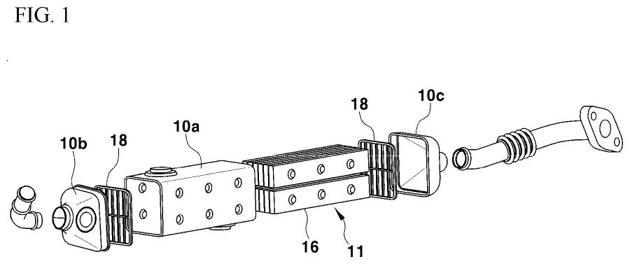

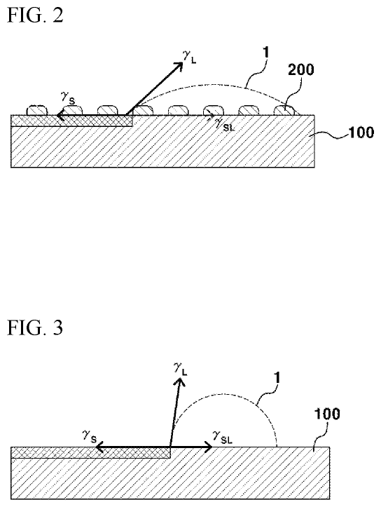

FIG. 1 is a view showing an EGR cooler for brazing joint according to an embodiment of the present disclosure, FIG. 2 is a view showing a heat exchange unit for the EGR cooler for brazing joint according to an embodiment of the present disclosure, and FIG. 3 is a view showing a conventional heat exchange unit for an EGR cooler for brazing joint.

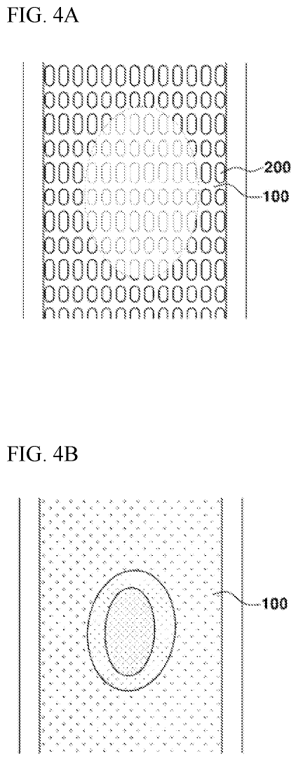

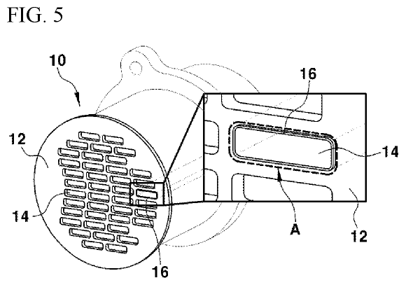

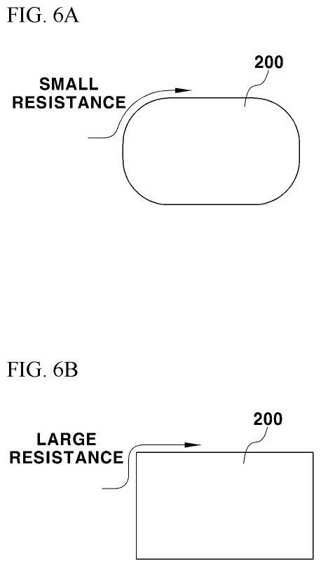

In addition, FIG. 4A and FIG. 4B are views showing spreadability of a filler metal for the EGR cooler for brazing joint according to an embodiment of the present disclosure, FIG. 5 is a view showing a brazing joint area of the EGR cooler for brazing joint according to an embodiment of the present disclosure, and FIG. 6A and FIG. 6B are views showing a shape of a protrusion for the EGR cooler for brazing joint according to an embodiment of the present disclosure.

As shown in FIG. 1, an EGR cooler 10 includes an inlet 10b configured to form an inlet area through which intake air and recirculation exhaust gas are supplied, a heat exchange unit 11 formed to be provided with a gas tube 16 connected to the inlet 10b and an outlet 10c and disposed inside a housing 10a and end plates 18 disposed to face the inlet 10b and the outlet 10c, respectively, and the outlet 10c configured to form an outlet area through which the intake air and the recirculation exhaust gas mixed by passing through the heat exchange unit 11 are discharged.

In a structure of the EGR cooler 10 as described above, each of the inlet 10b, the heat exchange unit 11, and the outlet 10c is brazing-joined to each other, and a guide pattern guiding a filler metal flow so that surface energy of a filler metal 1 applied for brazing joint is increased may be transferred to each joined area, thereby improving spreading performance of the applied filler metal 1 to improve brazing joint quality.

In general, the brazing joint technique is to perform an operation from an operating temperature of 450° C. or higher to a melting point temperature or lower of a base metal to be joined, and refers to a joint technology that joins two base materials by applying flux, filler metal, and heat to the two base materials, and does not deform the base material in the operating process.

In other words, the filler metal 1 joins the two base materials as it is melted by heat upon brazing, and as the filler metal 1, an alloy containing silver, copper, zinc, cadmium, phosphorus, nickel, manganese, tin, aluminum, silicon, and lead in consideration of the type and melting point of the base material and an affinity with the base material is selected and used.

The brazing joint technique is one of the most widely used joint techniques in the course of rapid industrial development today, and is widely used throughout the automobile industry, aerospace industry, refrigeration and air conditioning industry, household goods industry, accessory industry, and other industries.

The brazing joint technique is characterized in that a post-processing cost for mechanical processing such as grinding or filing is not required because a clean joined surface may be obtained after brazing, various joints are possible regardless of homogeneous or heterogeneous metal, and a plurality of parts may be joined in a finished-assembled state, thereby not only reducing the joint process and costs accordingly, but also having superior airtightness.

A principle of the above-described brazing joint technique is as follows.

In the brazing, when a heating source is applied to both base materials facing each other to reach a constant temperature, the filler metal 1 melts and permeates into pores between the two base materials to strongly join the base materials, and usually, the property indicating the degree of affinity of the base material and the filler metal 1 is called wettability, and the phenomenon in which the filler metal 1 is introduced between joint gaps corresponding to the pores of the base material is called capillary action.

As a result, in the brazing joint technique, there is a problem in that when the filler metal 1 has poor wettability with the base material, the joint is not performed well, and when the joint gap is increased, the filler metal 1 is not filled between the base materials, resulting in incomplete joint.

As described above, in order to improve the wettability of the filler metal 1, the mutual energy relationship between the base material and the filler metal 1 is important, and accordingly, as shown in FIG. 2, when a main body 100 made of ferritic stainless steel is formed with a plurality of protrusions 200, it is possible to maximize the surface energy of the filler metal 1 on the main body 100 to which the protrusion 200 is coupled, thereby improving the spreading performance of the filler metal 1.

In other words, in a case in which the filler metal 1 is applied and spread from the main body 100 corresponding to the base material, the surface energy γ_{S} of the main body 100, the surface energy γ_{L} of the filler metal 1, and the mutual energy γ_{SL} of the main body 100 and the filler metal 1 act at the tip of the filler metal 1 (see FIG. 2).

Here, in an energy equilibrium state for each, the energies may be expressed as Equation 1 below, and as a result, when the mutual energy γ_{SL} of the main body 100 and the filler metal 1 increases, the surface energy γ_{S} of the main body 100 also increases together, so that it may be inferred that the spreading performance of the filler metal 1 may be improved.

γ_{S}=γ_{L}·cos θ+γ_{SL} Equation 1

Accordingly, when the plurality of protrusions 200 are formed on an outer circumferential surface of the main body 100, the applied filler metal 1 flows and moves along the protrusion 200, which is to improve the mutual energy between the main body 100 and the filler metal 1, so that it is possible to maximize the surface energy of the main body 100 to improve the spreading performance of the filler metal 1.

Here, as shown in FIG. 6A, it is preferable that the protrusion 200 has an outer circumferential surface protruding from the main body 100 formed to be rounded, and this is to reduce the possibility of occurrence of voids and minimize the resistance because the filler metal 1 flows and moves in the applied direction (see an arrow direction in FIG. 6A), and is because for example, as shown in FIG. 6B, when the protrusion 200 has a rectangular cross-sectional shape, the possibility of occurrence of voids is high, and the filler metal 1 flows along the edge and moves away from the protrusion 200 (see an arrow direction in FIG. 6B), and as a result, the possibility of occurrence of an area where the filler metal 1 is not filled around the protrusion 200 is high.

As described above, in forming a continuous guide pattern for the main body 100 corresponding to the base material by forming the plurality of protrusions 200, the manufacturing may be made through the following method.

First, by rolling the main body 100 to be applied to each joined area of the inlet 10b, the heat exchange unit 11, and the outlet 10c of the EGR cooler 10 for brazing joint, heat-treating the main body 100 continuously rolled, and allowing the heat-treated main body 100 to pass through a rolling roller (not shown) on which the pattern has been transferred, a guide pattern composed of the plurality of protrusions 200, more specifically, the outer circumferential surface of the protrusion 200 may be formed to be rounded, the protrusion 200 protrudes at a maximum height of less than 60 μm, and a plurality of guide patterns having the same gaps may be transferred to the main body 100.

Meanwhile, in the conventional case, very small amounts of niobium (Nb), titanium (Ti), and aluminum (Al) elements are added as stabilizing elements to the main body 100 made of ferritic stainless steel in order to prevent intergranular corrosion or material sensitization, and these elements form an oxide layer on the surface in a brazing atmosphere (see FIG. 3), which acts as a cause of interrupting the flow of the filler metal 1 upon brazing and eventually degrading the spreading performance of the filler metal 1 as shown in FIG. 4B.

To this end, by applying the main body 100 made of austenitic stainless steel, it is possible to prevent the oxide layer from being formed on the surface in the brazing atmosphere as described above in advance, but there occurs a problem in that when the austenitic stainless steel having an expensive nickel content is used, the manufacturing costs increase.

Accordingly, in this embodiment, by applying the plurality of protruding protrusions 200 to the main body 100 made of ferritic stainless steel that does not contain the expensive nickel component, it is possible to secure brazing joint performance through the improvement in the spreading performance of the filler metal 1 compared with the related art (see FIG. 4A) and to save costs and improve quality by increasing the use of the main body 100, specifically, low-alloy ferritic stainless steel.

Meanwhile, in an EGR system, a plurality of members are provided separately from each other and are coupled to each other through the brazing joint, and among them, for example, as shown in FIG. 5, in the EGR cooler 10 installed in the exhaust gas recirculation line in order to cool the recirculated exhaust gas, the brazing joint is performed by inserting the plurality of gas tubes 16 for heat exchange into a plurality of tube assembly units 14 provided in a header 12.

In the EGR cooler 10, the tube 14 is made of ferritic stainless steel, and a plurality of protrusions 200 having regular gaps are formed on the outer circumferential surface thereof to guide the flow of the filler metal 1 upon brazing joint, so that it is possible to improve joint performance through the improvement in the spreadability of the filler metal 1.

In other words, when the filler metal 1 is applied to a bending area of a brazing joint A in a state in which the gas tube 16 is disposed to be inserted into the tube assembly unit 14 of the header 12, a structure in which the spreading performance of the filler metal 1 is improved by the protrusion 200 is obtained, so that the filler metal 1 may easily move up to a center area of the brazing joint A having a predetermined length, thereby improving the joint quality by the filler metal 1 evenly spread upon brazing joint.

Here, it is preferable that the protrusion 200 is formed to protrude from the main body 100 to a maximum height of less than 60 μm.

This is because it is usually known that in performing the brazing joint by allowing the filler metal 1 to permeate into the pores between the two base materials, the pore does not affect the joint strength up to 120 μm or less, and as in this embodiment, when the plurality of protrusions 200 are formed to protrude, the pores are inevitably reduced.

In addition, in a case in which the coupling between other members in the EGR system other than the coupling between the header 12 and the gas tube 16, that is, the coupling between the facing main bodies 100 in which the protrusions 200 are formed on both the facing main bodies 100 is made, when the protruding height of the protrusion 200 exceeds 60 μm, a gap between the main bodies 100 exceeds 120 μm, which affects the joint strength upon brazing joint, so that the protrusion 200 may preferably protrude at the maximum height of less than 60 μm.

According to the present disclosure, it is possible to increase surface energy (area) of the filler metal contact surface and maximize interaction energy between the base material and the filler metal upon brazing joint by applying the plurality of protrusions on the outer circumferential surface of the joint pipe body in order to improve brazing joint performance for expanding the use of low-alloy ferritic stainless steel in the EGR cooler system, thereby improving the brazing joint quality through the improvement in the spreadability of the filler metal.

Accordingly, according to the present disclosure, it is possible to improve the quality and save costs by expanding the use of the low alloy ferrite stainless steel and minimizing the use of expensive nickel-based filler metal containing the nickel component.

The present disclosure has been described above with reference to the embodiment(s) shown in the drawings, but this is only illustrative, and those skilled in the art will understand that various modifications therefore is possible, and all or some of the above-described embodiment(s) may also be selectively combined and configured. Accordingly, the true technical scope of the present disclosure should be defined by the technical spirit of the appended claims.

What is claimed is:

1. An EGR cooler for brazing joint comprising:
an inlet configured to form an inlet area through which intake air and recirculation exhaust gas are supplied;
a heat exchange unit formed with a gas tube connected to the inlet and through which the supplied intake air and the recirculation exhaust gas pass; and
an outlet configured to form an outlet area through which the intake air and the recirculation exhaust gas mixed by passing through the heat exchange unit are discharged,
wherein the inlet, the heat exchange, and the outlet are brazing-joined, and a guide pattern configured to guide the flow of a filler metal so that surface energy of the filler metal applied for brazing joint is increased is transferred to each joined area.

2. The EGR cooler for brazing joint of claim 1,
wherein the guide pattern is formed with a pattern through which a plurality of protrusions protrude.

3. The EGR cooler for brazing joint of claim 2,
wherein the guide pattern has an outer circumferential surface of the protrusion formed to be rounded.

4. The EGR cooler for brazing joint of claim 2,
wherein the guide pattern has the protrusion formed to protrude at a maximum height of less than 60 μm.

5. The EGR cooler for brazing joint of claim 2,
wherein the guide pattern is formed by the protrusions spaced apart from each other by the same gap.

6. The EGR cooler for brazing joint of claim 1,
wherein the heat exchange unit is provided with a housing, the gas tube disposed inside the housing, and end plates disposed to face the inlet and the outlet, respectively.

7. The EGR cooler for brazing joint of claim 1,
wherein the heat exchange unit has the protrusions formed at both ends with respect to a surface of the gas tube.

8. The EGR cooler for brazing joint of claim 1,
wherein the heat exchange unit is made of ferrite stainless steel.

9. A method of manufacturing an EGR cooler for brazing joint, the method comprising:
a rolling operation of rolling a base material applied to each joined area of an inlet, a heat exchange unit, and an outlet of an EGR cooler for brazing joint;
a heat-treating operation of heat-treating the base material passing through the rolling operation; and
a guide pattern forming operation of forming a guide pattern by allowing the heat-treated base material to pass through a rolling roller on which a pattern is transferred and composed of a plurality of protruding protrusions, wherein the guide pattern has an outer circumferential surface of the protrusion formed to be rounded and protrudes at a maximum height of less than 60 μm, and a plurality of protrusions are formed to have the same gaps therebetween.
